(19) United States
(12) Patent Application Publication
(10) Pub. No.: US 2015/0056977 A1
(43) Pub. Date: Feb. 26, 2015

(54) Telephone Call Log

(71) Applicant: Mark Wisnosky, San Diego, CA (US)

(72) Inventor: Mark Wisnosky, San Diego, CA (US)

(21) Appl. No.: 14/459,351

(22) Filed: Aug. 14, 2014

Related U.S. Application Data
(60) Provisional application No. 61/866,969, filed on Aug. 16, 2013.

(51) Int. Cl. H04M 1/725

(52) U.S. Cl. CPC H04M 1/72566; H04M 1/72597
USPC 455/418

(57) ABSTRACT

A telephone call log including a system to produce the log and methods is described. A programmable telephone is programmed to monitor telephone activity on a telephone and create a calendar entry in a calendar application also operating on the telephone. The calendar entry can be synchronized across devices such that notes can be created on a separate device and associated with the calendar entry. In one embodiment handwritten notes may be linked as a file to the calendar entry. In another embodiment the phone log application further monitors the location of the phone and the calendar entry of the phone log further includes the location, speed and heading of the phone at the time the call was made or received.

### CROSS-REFERENCE TO RELATED APPLICATIONS

This application claims priority to U.S. Provisional application 61/866,969 filed 16 Aug. 2013, titled Telephone Call Log, by the same inventor and currently pending.

### BACKGROUND OF THE INVENTION

1. Technical Field The present invention relates to systems and methods for automatic logging of telephone calls.

2. Related Background Art

The need for logging telephone calls along with notes taken during a call exists in many professions. In many professions if it is not mandatory to log calls it is a t least a best practice. Many professionals such as doctors and lawyers log calls and all interactions with clients. There are numerous manual methods for logging telephone calls. The most common is a handwritten logbook or calendar/diary. Automated systems if they exist at all are incorporated into expensive private phone systems or networks. Typically a manual system such as handwritten notes is not compatible with the automated systems. Many automated systems simply make a data entry of calls made or received but do not provide for means to incorporate notes into the call log. No automated systems allow incorporation of handwritten notes into an automated call logging system. Taking notes on a mobile telephone while at the same time talking on the phone is difficult if not impossible. There is a need for a system that allows use of a mobile phone device to accept calls while simultaneously automatically allowing the user to take notes regarding the call on a second device such as a tablet or computer or even a piece of paper. There is a need for a system that synchronizes the phone log across multiple devices and allows entry of phone notes through a phone, computer, and computer tablet as well as handwritten notes or any other paper document. All the forms of entering the phone notes should be available while the phone call is taking place as well as adding or editing the notes after the call has been completed.

Typically professionals who are in need of a call logging system are not always located exclusively in the office. Doctors may be traveling between the office and the hospital. Attorneys may be in the office, on the road or at court. There is a need for a system that automatically logs calls regardless of the location of the phone user. There is a need for a system that allows the user to access the call log and notes across a variety of devices. Knowledge of where the telephone was located at the time the call is received can be a great aid in recalling the phone call. There is a need or a system that logs a phone call with the date and time of the call as well as other data such as the geographic location of the telephone at the time the call is made or received.

### DISCLOSURE OF THE INVENTION

A system is described that addresses the deficiencies of the current art systems described above. A phone call logging system that includes a mobile telephone device and other computing devices is described. In one embodiment a phone call whether originated or received creates a log entry in a calendar with the date and time of the call and allows for entry of notes and attached files to create a log of the telephone call. In one embodiment the call log system operates on a smart telephone or other communication device that includes a programmable computing device. The programmable computing device includes the ability to create a calendar or includes a calendar application in which new entries can be automatically made upon an action of initiating or receiving a phone call. In another embodiment the call log system operates across a plurality of devices including a smart telephone, a computer tablet, a portable computer a desktop computer and a networked server that interconnects all of the devices and synchronizes data entered amongst the devices. In another embodiment the smart telephone further includes a global positioning device and the phone call log entry in a calendar further includes the location of the telephone at the time the call was made or received. In another embodiment the call log system operates across a plurality of networked devices and the call log entry in a calendar may be edited by any of the networked devices while the call is in progress as well as after the call is completed. In another embodiment a file may be attached to the calendar entry. Nonlimiting exemplary files include a photograph, an email attachment and a scanned image of handwritten notes or any other paper document.

### BRIEF DESCRIPTION OF THE DRAWINGS

FIG. 1 is a block diagram showing device components in a system for practicing the invention.

FIG. 2 is a block diagram showing software components in a system for practicing the invention.

FIG. 3 includes flow charts of embodiments of the invention.

FIG. 4 is a block diagram of an embodiment of the invention.

FIG. 5 is a diagram of some main elements of the system.

### MODES FOR CARRYING OUT THE INVENTION

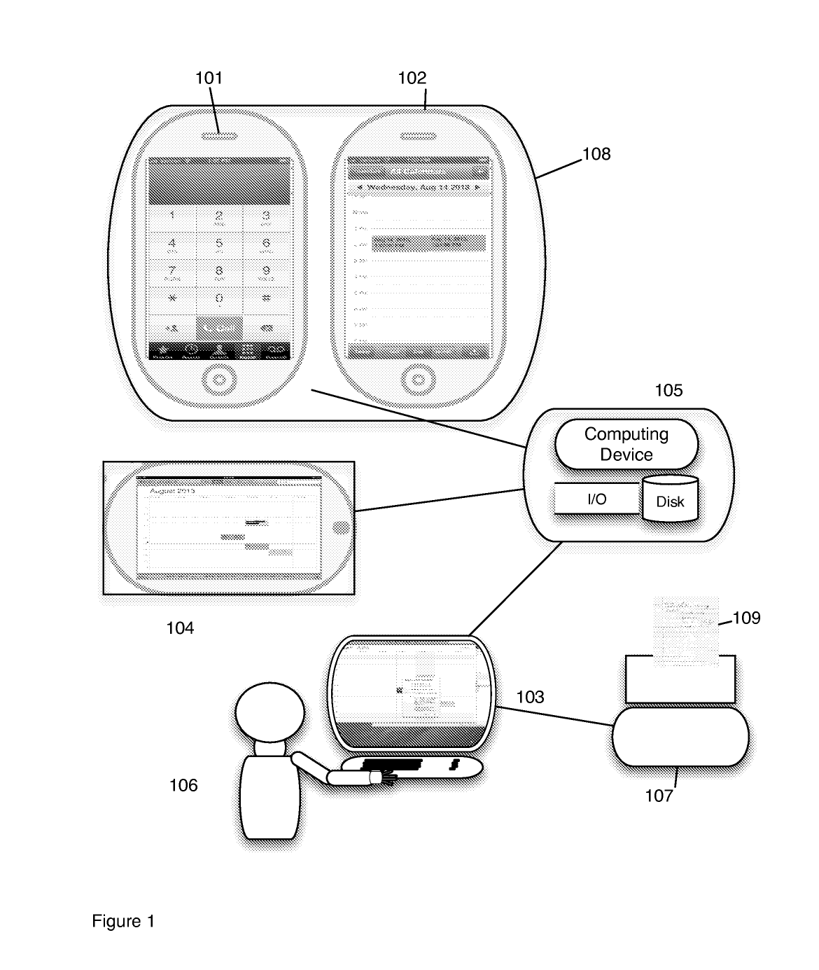

Referring to FIG. 1 an exemplary system used to practice the invention is shown. The system is comprised a telephone device 108 that can be programmed to include both a telephone application 101 and calendar application 102. In the preferred embodiment the applications are included in the same device 108. The telephone device further includes a computing device that is programmable such that when there is activity on the telephone application a second application, the phone logging application, can be programmed to place an entry in the calendar application 102. In one embodiment the entire invention is located within a single telephone device 108 and no further devices are required for practice of the invention. In the case of a single device the invention is comprised of a telephone device including a computing device. The computing device is programmed to include a telephone application, a calendar application and a phone log application that creates a calendar entry within the calendar application upon sending or receiving a phone call through the telephone application. The telephone application may use a wired telephone network, a cellular network or may be a voice over internet (Voip) application. The telephone device 108 is in communication with a server 105. In another embodiment further devices are included. Nonlimiting examples of further devices include a computing tablet device 104 and a personal computer 103. Both the tablet device 104 and the computer 103 further include a calendar application that may be updated by communication through the server 105. In the preferred embodiment the calendar application on all devices 108, 104, 103 are synchronized through the server 105. Synchronization means that changes made in a calendar entry on any of the devices will result in the same changes being reflected in the calendar application on all of the devices. In one embodiment a phone call sent or received on the telephone device 108 will result in a calendar entry on the calendar application 102 of the telephone device, which through the synchronization through the server 105 results in a calendar entry on other interconnected devices 104, 103. In the preferred embodiment the calendar entry on the telephone device and the synchronization take place at the onset of a telephone call such that during the call a user 106 may enter notes related to the call on any of the devices 103, 104, 108. In another embodiment notes can be taken by handwriting on a piece of paper 109 and then using a scanner 107 attached to the computing device be digitized to create an image file or through optical character recognition to create a text file that may then further be linked to the calendar entry in the calendar application running on the computer device 103 and further through synchronization through the server 105 appear as a linked file on all devices 103, 104, 108. The example shown includes three exemplary devices in communication but it should be understood that the number of devices is not limited and generally in the preferred embodiment a plurality of linked devices are included.

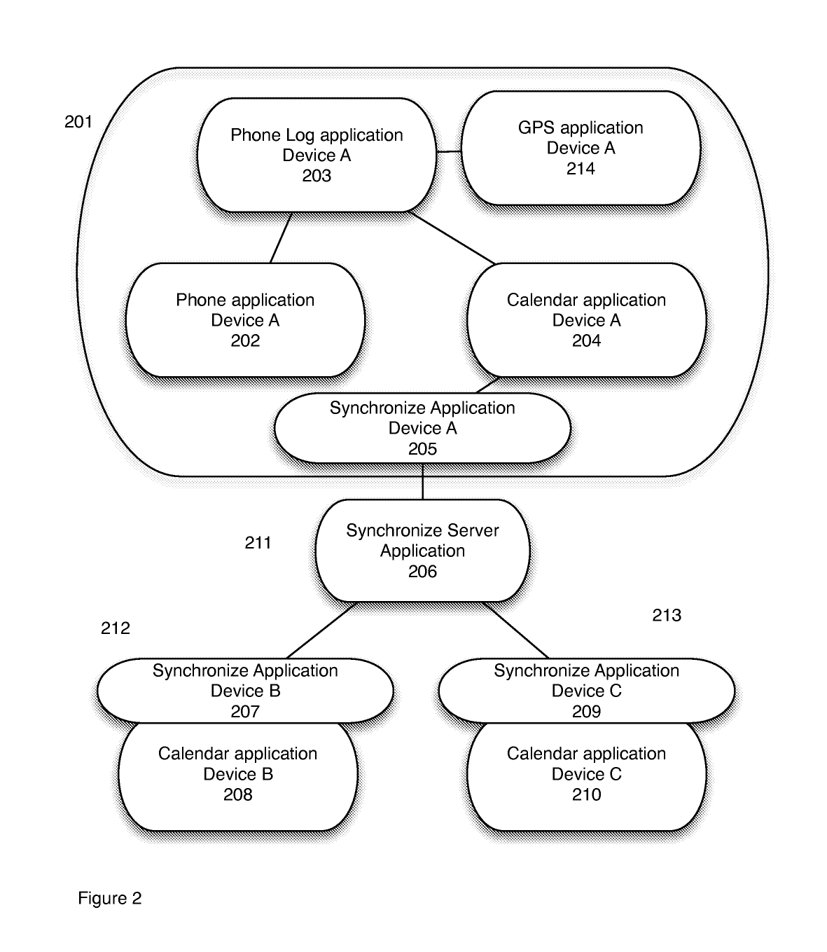

Referring now to FIG. 2 a block diagram that includes both hardware and software components is shown. A first telephone device 201 includes a computing device. The telephone device, also designated as Device A, is programmed to perform certain functions. The first 202 is a phone application. When activated by sending or receiving a telephone call, a phone log application 203, responds by creating an entry in a calendar application 204. In one embodiment the telephone device further includes a global positioning device (GPS) and associated software 214. Upon activation by phone activity the phone log application further queries the GPS and the calendar entry created further includes location heading and speed information. The telephone device 201 further includes an application 205 that synchronizes data amongst multiple devices. The Synchronize Application 205 causes communication of data through a server 211 that is programmed to include a synchronize server application 206 that communicates data amongst a plurality of devices 212, 213. An example of a further device 212 includes a tablet computing device. The tablet computing device 212 is further programmed with a synchronize application 207 that is programmed to create an entry on a calendar application 208 also operational on the second device 212. Similarly a third device 213, also designated as device C includes a synchronize application 209 and a calendar application 210 that upon receiving a signal from the server application 206 creates a calendar entry equivalent to the first calendar entry created on the telephone device 201. Device C may be any of the type of devices already discussed including another telephone device, a tablet, a portable computer and a desktop personal computer. The devices may communicate by wired or wireless means including communicating over the Internet. The synchronization communication is bi-directional. That is a user can further enter information such as notes related to the phone call on any of the devices and the calendar applications and synchronization applications respond to edits or changes to the calendar entry and communicate the information across all linked devices. The devices that are linked are typically selected through setting user preferences in the synchronization and calendar applications as is known in the art.

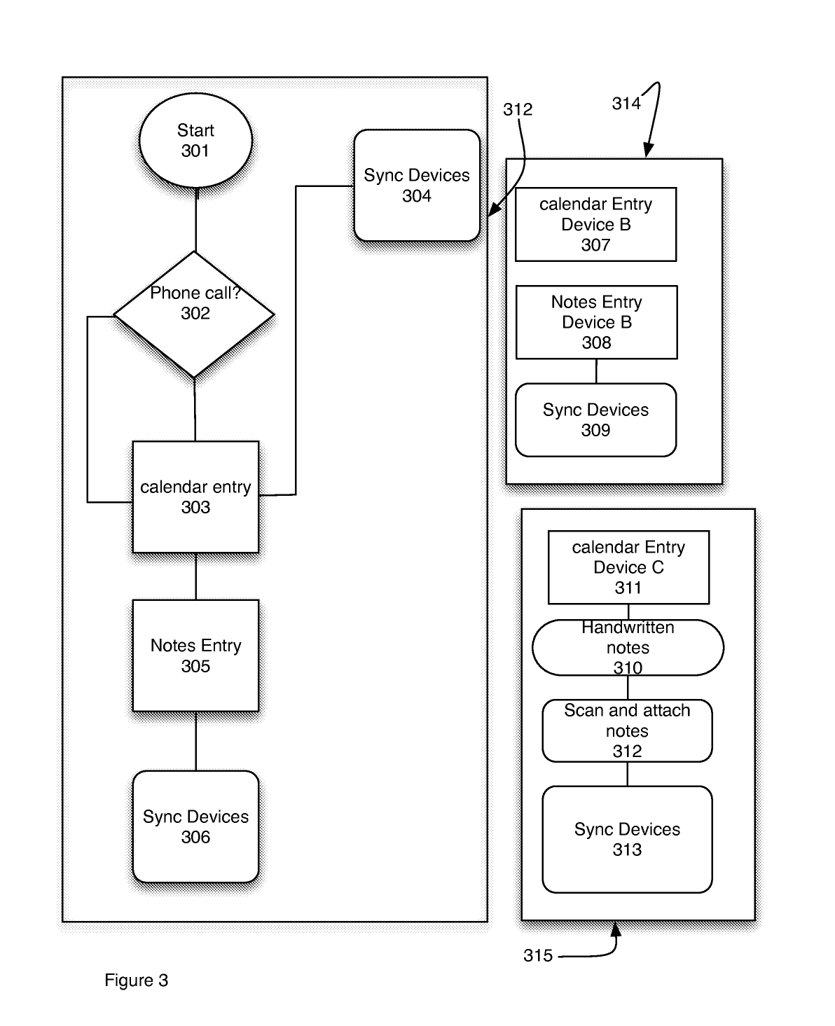

Referring now to FIG. 3, flow charts for process embodiments of the invention are shown. A first process 312 is operational on a telephone device. The process is started 301 with initiation of a telephone application, a phone log application and a calendar application on the telephone device. The phone log application waits for either an incoming or outgoing phone call 302. Upon either event the phone log application sends a command to the calendar application to create a calendar entry and then returns to 302 to monitor phone activity. In one embodiment, once the calendar entry is created 303 a synchronization process 304 creates equivalent calendar entry on linked devices. In one embodiment where the telephone is a stand-alone device and not linked to other devices the synchronization processes 304, 306 do not take place. In another embodiment wherein the telephone device further includes a gps device the calendar entry 303 includes entering the time, location, heading and speed of the telephone at the time the calendar entry is made. The process may continue with the user entering notes 305 in the calendar application associated with the calendar entry 303. Again in an embodiment where multiple devices are linked the modification of the calendar entry is followed by synchronization 306 across linked devices such that the calendar entries on all devices contain equivalent information. A second parallel process 313 includes creation or modification of notes on a second device “B”. The second device is physically separate from the telephone device and linked electronically. A calendar entry is created 307 as a result of the synchronization process with Device A and the user may edit or add notes to the calendar 308 entry. The device then follows by a synchronization process 309 such that the newly entered notes are available on all linked devices. Another embodiment includes a third parallel process 315. The previous process 312 creates a calendar entry upon initiation of phone activity and the calendar entry 311 is created on a separate device C. In one embodiment device B and C are the same device and process described herein are operational on the single device. Handwritten notes are created 310 by the user and the notes are electronically scanned and attached to or linked to the calendar entry 312. Handwritten notes may further include any other paper document. The device then synchronizes data 313 such that the modified calendar entry appears with the scanned and linked notes on all devices.

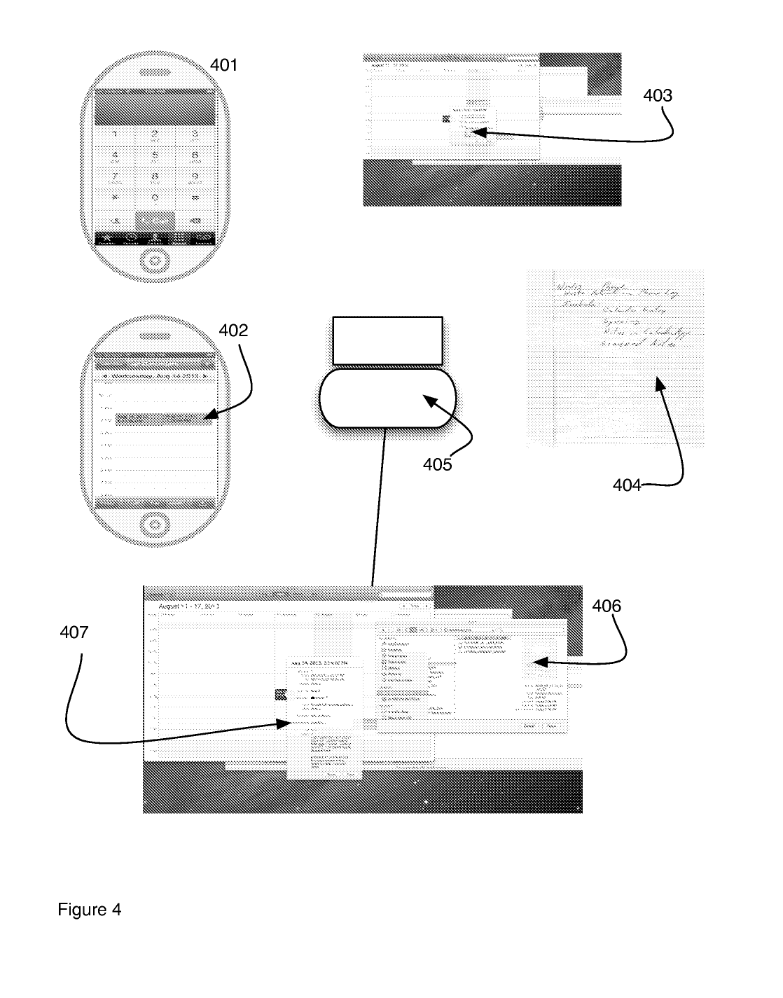

The process of FIG. 3 are further illustrated in the block diagram of FIG. 4. A telephone device includes a telephone application 401 and a calendar application 402. Upon receiving a phone call a phone log application running in the background that monitors the telephone activity creates an entry in the calendar application (also indicated by 402) and the device synchronizes the calendar entry across multiple pre-selected devices. The same calendar entry appears upon a calendar application on a separate computing device 403. The user may further create notes 404 which are digitized by scanning 405 on a scanner attached to the separate second computing device the notes file 406 is then linked to the calendar entry 407.

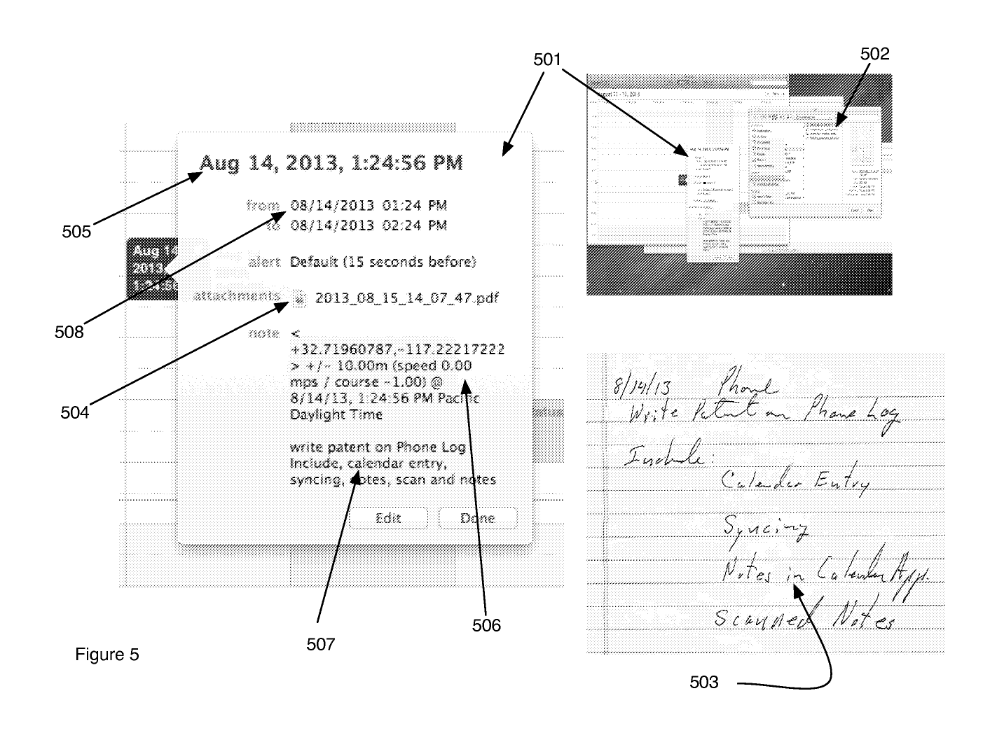

Details of embodiments of the invention are shown in FIG. 5. A telephone log application monitors the telephone activity and when a phone call is made or received creates a calendar entry in a calendar application 501. In one embodiment the calendar entry includes the date and time 505 that the telephone call was made or received, and the date and time when the calendar entry 508 was created.

In one embodiment where the telephone further includes a GPS the telephone log operation further enters information 506 regarding the location, speed, heading and GPS time of the telephone when the call activity was detected and the calendar entry made. The calendar entry can further includes notes 507 created by the user on the telephone device or another linked device and then synchronized to appear on the calendar device. In another embodiment, handwritten notes 503 are scanned and digitized creating a file 502 that is linked 504 to the calendar entry. In one embodiment the notes file includes the date and time that the notes were scanned 504. In the illustrated case the phone call occurred on Aug. 14, 2013 at 1:24:56 PM pacific daylight time and the notes were scanned on Aug. 15, 2013 at 2:07:47 PM. In this manner there is some evidence as to whether the handwritten notes and the phone call were created at the same time. The evidence in the illustrated case is that the handwritten notes were logged a day after he phone call.

### SUMMARY

A telephone call log including a system to produce the log and methods is described. A programmable telephone is programmed to monitor telephone activity on a telephone and create a calendar entry in a calendar application also operating on the telephone. The calendar entry can be synchronized across devices such that notes can be created on a separate device and associated with the calendar entry. In one embodiment handwritten notes may be linked as a file to the calendar entry. In another embodiment the phone log application further monitors the location of the phone and the calendar entry of the phone log further includes the location, speed and heading of the phone at the time the call was made or received.

Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

What is claimed is:

1. A telephone call log system comprising:
a) a telephone, said telephone including a computing device,
b) said computing device programmed to monitor a telephone application for telephone activity and when telephone activity is detected to create an entry in a calendar application operating on the computing device of the telephone,
c) said entry including the date and time the telephone activity was detected.

2. The telephone call log system of claim 1 wherein the telephone further includes a global positioning device and the computing device is further programmed to monitor the location, speed of movement and heading of the telephone and said entry in the calendar application further includes the location, speed of movement and heading of the telephone.

3. The telephone call log system of claim 1 further including:
a) a server in electronic communication with the telephone,
b) a plurality of computing devices, said plurality of computing devices in electronic communication with the server, and,
c) the computing device of the telephone is further programmed to communicate through the server to the plurality of computing devices and the plurality of computing devices are programmed to receive communication from the server wherein when the calendar entry is created on the calendar application on the telephone computing device a calendar entry containing equivalent information is created on the calendar application on the plurality of computing devices.

4. The telephone call log system of claim 2 further including:
a) a server in electronic communication with the telephone,
b) a plurality of computing devices, said plurality of computing devices in electronic communication with the server, and,
c) the computing device of the telephone is further programmed to communicate through the server to the plurality of computing devices and the plurality of computing devices are programmed to receive communication from the server wherein when the calendar entry is created on the calendar application on the telephone computing device a calendar entry containing equivalent information is created on the calendar application on the plurality of computing devices.

5. The telephone call log system of claim 3 further including a scanner, said scanner in electronic communication with at least one of the plurality of computing devices wherein the at least one of the plurality of computing devices is programmed to create a digital file of a paper document and link said digital file to the calendar entry.

6. The telephone call log system of claim 4 further including a scanner, said scanner in electronic communication with at least one of the plurality of computing devices wherein the at least one of the plurality of computing devices is programmed to create a digital file of a paper document and link said digital file to the calendar entry.

7. A method for creating a telephone call log said method comprising:
a) Programming a computing device located within a telephone to monitor a telephone application for telephone activity and when telephone activity is detected to create an entry in a calendar application operating on the computing device of the telephone,
b) said entry including the date and time the telephone activity was detected.

8. The method of claim 7 wherein the telephone further includes a global positioning device and the method further includes monitoring the location, speed of movement and heading of the telephone and said entry in the calendar application further includes the location, speed of movement and heading of the telephone.

9. The method of claim 7 further including:
a) programming the computing device in the telephone to be in electronic communication with a server,
b) programming the server to be in electronic communication with a plurality of computing devices, and,
c) programming the computing device of the telephone to communicate through the server to the plurality of computing devices and programming the plurality of computing devices to receive communication from the server wherein when the calendar entry is created on the calendar application on the telephone computing device a calendar entry containing equivalent information is created on the calendar application on the plurality of computing devices.

10. The method of claim 8 further including:
a) programming the computing device in the telephone to be in electronic communication with a server,
b) programming the server to be in electronic communication with a plurality of computing devices, and,
c) programming the computing device of the telephone to communicate through the server to the plurality of computing devices and programming the plurality of computing devices to receive communication from the server wherein when the calendar entry is created on the calendar application on the telephone computing device a calendar entry containing equivalent information is created on the calendar application on the plurality of computing devices.

11. The method of claim 9 further including programming at least one of the plurality of computing devices to create a digital file of a paper document when said at least one of the plurality of computing devices is in electronic communication with a scanner and creating a link to said digital file in the calendar entry.

12. The method of claim 10 further including programming at least one of the plurality of computing devices to create a digital file of a paper document when said at least one of the plurality of computing devices is in electronic communication with a scanner and creating a link to said digital file in the calendar entry.
